(19) United States
(12) Patent Application Publication
(10) Pub. No.: US 2005/0021405 A1
(43) Pub. Date: Jan. 27, 2005

(54) Business method for promoting sale of merchandise and novel smiles stamps or gift stamps of philatelic value for use in promoting business by sale of merchandise

(76) Inventor: Sanjiv Agarwal, Kolkata (IN)

Correspondence Address: BAKER BOTTS L.L.P., 2001 ROSS AVENUE, SUITE 600, DALLAS, TX, 75201-2980, US

(21) Appl. No.: 10/919,108

(22) Filed: Aug. 16, 2004

Related U.S. Application Data
(63) Continuation-in-part of application No. PCT/IN03/00026, filed on Feb. 14, 2003.

(30) Foreign Application Priority Data
Feb. 19, 2002 (IN) 94/CAL/2002

(51) Int. Cl. G06F 17/60

(52) U.S. Cl. 705/14

(57) ABSTRACT

A novel coupon/stamp is presented that allows for multiple coupons/stamps to be provided on a single sheet. Each coupon/stamp may have a unique added value and the sheet is formed so that any coupon/stamp may be removed from the sheet without separating any other coupon/stamp from the sheet. In addition, a method is presented for issuing the coupon/stamp as well as an ability to redeem the coupon/stamp.

### RELATED APPLICATIONS

The present application claims priority to and is a continuation-in-part application of PCT International Application No. PCT/IN03/00026 filed Feb. 14, 2003 which claims priority to India Application No. 94/CAL/2002 filed Feb. 19, 2002.

### INTRODUCTION TO THE FIELD OF INVENTION

This invention in one aspect relates to a business method for promoting sale of merchandise.

In another aspect, this invention relates to novel SMiles stamps or gift stamps of philatelic value for use in promoting business by sale of merchandise.

### PRIOR ART AND DRAWBACKS

It is already known to prepare gift type of stamps or coupons for promoting sales of any saleable commodity and customer loyalty to any establishment. The present day concept is based on preparing discount stamps or coupons or scratch stamps/coupons etc. of certain discount value or for gift items and/or prizes.

These gift type stamps or coupons have very limited value and applications or use.

The gift stamps/coupons are valuable to the customer even to the limited extent with respect to one particular trader or distributor and sometimes is limited to time, area and type of goods.

Moreover, these gift stamps/coupons have no philatelic value to anybody, cannot be purchased or traded or exchanged.

There are some trading stamp programs in vogue in modern countries esp. USA, but they are limited to printing and issuing unattractive monolith coupon type of stamps as tradable incentive, with no collectors' value except its trading power against gifts or commodities. There are still other electronics or card based reward programs like frequent flier or ‘points’ scheme of some credit cards, also in vogue in our country.

Consumer rewards, incentives and premiums are a historically known practice of sellers to achieve the objectives of maximizing sales and loyalty. Merchants are known to award incentives to the consumer patronizing them, by various ways like gifts, discounts, reward coupons, and collectibles. It is well known to prepare gift type of stamps or coupons for promoting sales and customer loyalty. The present day concept is based on preparing incentive stamps or coupons or scratch cards of certain value or a chance to win prizes. These stamps, coupons, and cards have very limited value and applications of use with respect to one particular trader or distributor and sometimes is limited to time, area, and type of benefit for which they can be exchanged. There are some trading stamp programs limited to printing and issuing unattractive monolith coupon type of stamps of a particular value as tradable incentive, with no collectors' value except its trading power against gifts or commodities. Moreover, this type of stamp is cumbersome as it is bulky and requires a lot of manual handling. That is the reason perhaps why automated programs are more in fashion. These gift stamps or coupons have no philatelic value to anybody after redemption and cannot be purchased or traded or exchanged. As a result, consumers have no motivation to keep on collecting such stamps, apart from the only objective of redemption against a fixed reward. None of these stamps, coupons or cards can be exchanged for, added to, or converted into points of an electronic program such as explained below.

The most recent practice of many sellers to attract and retain customers is to administer frequent buying programs that offer awards in the form of points or miles, for example ‘frequent flier’ programs that most airlines offer or ‘points’ scheme of some credit cards. These are generally administered by the merchants themselves. Of late, it is known that a number of merchants come together to form an alliance, for example Airmiles of Canada, whereby the consumer can earn and accumulate rewards across a number of establishments like airlines, hotels, clubs, restaurants etc. The drawbacks of the above are now well known as they require the consumers to keep track of a plethora of accounts and identification of cards or numbers. As a result, a large percentage of these rewards are never redeemed or cannot be meaningfully redeemed due to small fragmentary values. Moreover, there are studies that show these programs are disproportionately costly to maintain and hence remain outside the reach of relatively smaller players.

Another drawback of card based points schemes is the exclusive dependence on electronic and computer technology, rendering it ineffective if the required infrastructure is not available or affordable. Yet another drawback is faced when the consumer fails to produce the card. Moreover, these points are not transferable and can not be combined with other's points. Further drawbacks of the point systems in vogue are that they always require the consumer to go through some procedure of enrollment into a program and identify at the time of each transaction by way of some kind of a magnetic card or indicator of identification. Apart from such procedures being time consuming, the reward points so awarded are not in a transferable instrument for redemption. In all such programs, the privacy of the consumer is invaded several times due to compulsory identification at each level.

One more major drawback of present day point systems it that the same points can not be put in or on the package by the manufacturer or an intermediary in the supply chain, leaving these programs limited in application at the last point of sale only. The resultant major drawback of present loyalty programs and systems is such that the consumers take scant or passing interest in these due to all other drawbacks mentioned above yet these cost the sellers considerable effort to operate. The latest variety of loyalty programs includes a computerized network wide or Internet based points or tokens or mileage program scheme which provide incentives on purchases made through the network. They have similar disadvantages as above. Moreover, no computer dependant program teaches how to integrate a wide variety of establishments including smaller merchants who would not like to provide for computerized gadgets, into the program. Thus a need exists for a broad based, cost-effective, improved method of loyalty program that will be convenient, meaningful, and interesting for the consumers.

### OBJECTS OF THE INVENTION

It is therefore an object of this invention to propose a novel type of discount stamps/coupons, which will have unlimited applications.

It is another object of this invention to propose such a novel type of gift stamps/coupons, which will have philatelic value and will be the delight of the collector.

It is yet another object of the invention to propose a novel type of gift stamps/coupons, which can be treated or used elsewhere also in addition to the source from where it has been obtained.

It is a further object to propose such a novel gift stamps/coupons, which will have value for wider area and application and can be discounted/redeemed between inter and intra traders.

It is a further object to propose such a gift stamps/coupons for discount purposes, which can be made secure and reliable.

Most merchants already pay around 2% more or less on credit card transactions.

Another object of this invention is to pay back to the cash purchasers an incentive in lieu of this, by introducing a cash card juxtaposed to credit card, although it does not purport to make it a limitation.

In fact, many credit card companies and other establishments like airlines, retailers etc. have their own incentive schemes.

Another object of this invention is to enroll such establishments as outsource, acting as a clearing house of all such schemes.

Another object of this invention is to add value to a vast body of general consumers by making them avail incentives on a larger scale, encouraging small saving in masses and boost consumer demand.

It is a further object of this invention to propose a business method for promoting sale of merchandise.

These and other objects will be apparent from the following paragraphs.

It is also known to have tearable stickers on a tracking sheet, a two-sheet formation.

### BRIEF STATEMENT OF THE INVENTION

According to this invention there is provided a method for provided sale of merchandise comprising:

Providing a Smiles stamp gift coupon is associated with merchandise.

Said gift coupon having philatelic/exchange/encashment credit or monetary or other value added features therein,

Said features being prominently exhibited on one or both sides of the said coupon,

Said features being same or different on one or both sides of the coupon or a combination thereof,

Said features being for example, numerals, messages, teachings, pictures, puzzles, philatelic and/or information from various fields of learning and similar other features,

The sale of merchandise while being valued, also entitling the buyer for a limited value of the above gift coupon/s redeemable within a certain period of time as indicated in said coupon.

If required, said time being extendible as and when indicated,

Said coupon entitling the beneficiary buyer to enjoy the stated benefit either at the source of sale or retailer or wholesaler or manufacturer of the said merchandise or at any other similar person being a collaborator (member for a club or association of such persons having common coupon beneficiary schemes for cash or a discount on any merchandise of any of the said members and

the said coupon being further provided with cancellation facilities and returnable to the beneficiary purchaser for collection purposes enabling the beneficiary to start a philatelic or similar interest and collection of said cancelled coupon/s.

In this method the said value added features are printed on the said coupons preferably on one side thereof and the same can be profitably utilized as stated therein by the beneficiary buyer or by a group of beneficiary buyers.

In another method, there is provided a novel Universal Cash Card scheme, wherein an enrolled consumer, who pays in cash to a member establishment, gets a value as reward credited to his/her account by way of a cash card with an unique identification number, which, in one way, is an opposite of normally known credit card, because,
(a) it is to be used for purchases in cash rather than on credit.
(b) when a credit card is used, at any member establishment, the credit card company deducts a negotiated commission @ 2% more or less, while paying for the value of purchase, the credit card company in turn often returning a small portion of this commission back to the credit card holder by way of reward points or miles,
   whereas, in the case of cash card, which is based on the premise that the customer paying in cash will rightfully earn similar or more reward points or miles, by using the cash card, the member establishments will pay commission to a similar extent as above, to take care of the operational cost of the scheme from which a portion will be returned back to the consumer as reward.

The above cash card scheme may be run in conjunction with the Smiles and/or Universal Clearing House Schemes or independently.

In a modified method, I provide a Universal Clearing House of Consumer Rewards and Loyalty Schemes of several member establishments, wherein a centralized system keeps account of each consumer enrolled by crediting reward points or values earned at various member establishments and clubbing such reward points or values to be redeemed against points or values so accumulated at any point of time by the enrolled consumer, whereas, in the present system, establishments have their own system to keep account of consumers enrolled by crediting reward points or values earned only at that particular establishment. So the redeemable points or values so earned are limited to a particular establishment—which is a major limitation.

Sometimes a few establishments form alliance to honour each others' systems to club reward points or values earned at their respective establishments.

Thus a Universal Clearing House of Consumer Rewards and Loyalty Schemes will be a major improvement on the existing systems making it Novel.

The above Universal Clearing House of Consumer Rewards and Loyalty Schemes can be used in conjunction with our smiles and/or cash card schemes as well as independently.

According to another feature of the invention there is provided a gift coupon/smiles stamp for the promotion of sales, schemes and/or merchandise comprising a sheet material having a plurality of separable units formed therein, said units being arranged in rows and columns, each unit carrying a value added feature therein having philatelic/exchange/encashment/credit or monetary or other similar value, one or more of said units having the same or different value addition/s, said value additions being for example, numerals, messages, teachings and similar information.

The gift coupon has the following features:

a. the value additions are printed on one face of the coupon,

b. the said rows and columns are of same or different sizes,

c. the rows are formed horizontally or slantingly and each column is formed vertically or slantingly to form a multi sided coupon,

d. the said coupon is a triangular sheet having one unit in the first row and which is equilateral or right angular or isosceles or obtuse angled or

e. the said coupon is a square, rectangle or other polygonal sheet, which polygonal sheet includes a rhombus a parallelogram or other multisided figures.

f. all the units are of same size and shape and, any one side of one or more units is independently provided with a slit while the other sides are provided with perforations,

g. the slit is a continuous slit or intermittently formed slit and the slit is a through cut opening or a weakened tear line and

h. the reverse or back side of the sheet is plain and wherein, the back side is gummed across the units, fully or partly to make the units adhesive for collection purposes.

A number of sheets are formed into a booklet. The sheets are of same or different type and advertise one or more items of merchandise, the merchandise are same or different in the same sheet and the merchandise are of the same or different manufacturers.

A method for promoting sale of merchandise includes Providing a Smiles stamp gift coupon/Stamp is associated with merchandise, Said gift coupon/Stamp having philatelic/exchange/encashment credit or monetary or other value added features therein, Said features being prominently exhibited on one or both sides of the said coupon/Stamp, Said features being same or different on one or both sides of the coupon/Stamp or a combination thereof, Said features being for example, numerals, messages, teachings, pictures, puzzles, philatelic and/or information from various fields of learning and similar other features, The sale of a merchandise while being valued, also entitling the buyer for a limited value of the above gift coupon(s)/Stamp redeemable within a certain period of time as indicated in said coupon/Stamp. If required, said time being extendible as and when indicated. Said coupon/Stamp entitling the beneficiary buyer to enjoy the stated benefit either at the source of sale or retailer or wholesaler or manufacturer of the said merchandise or at any other similar person being a collaborator (member for a club or association of such persons having common coupon/Stamp beneficiary schemes for cash or a discount on any merchandise of any of the said members and the said coupon/Stamp being further provided with cancellation facilities and returnable to the beneficiary purchaser for collection purposes enabling the beneficiary to start a philatelic or similar interest and collection of said cancelled coupon(s)/Stamps.

A method as described above, wherein the said value added features are printed on the said coupons/Stamps preferably on one side thereof.

A modification of the method as described above, wherein there is provided a novel Universal Cash Card scheme, wherein an enrolled consumer, who pays in cash to a member establishment, gets a value as reward credited to his/her account by way of a cash card with an unique identification number, which, in one way, is an opposite of normally known credit card, because, (a) it is to be used for purchases in cash rather than on credit, (b) when a credit card is used, at any member establishment, the credit card company deducts a negotiated commission @ 2% more or less, while paying for the value of purchase, the credit card company in turn often returning a small portion of this commission back to the credit card holder by way of reward points or miles, whereas, in the case of cash card, which is based on the premise that the customer paying in cash will rightfully earn similar or more reward points or miles, by using the cash card, the member establishments will pay commission to a similar extent as above, to take care of the operational cost of the scheme from which a portion will be returned back to the consumer as reward and wherein the above cash card scheme may be run in conjunction with the Smiles and/or Universal Clearing House Schemes or independently.

A method as described above, wherein the Smiles and/or Cash Card is cleared through a Universal Clearing House of Consumer Rewards and Loyalty Schemes of several member establishments, wherein a centralized system keeps account of each consumer enrolled by crediting reward points or values earned at various member establishments and clubbing such reward points or values to be redeemed against points or values so accumulated at any point of time by the enrolled consumer, whereas, in the present system, establishments have their own system to keep account of consumers enrolled by crediting reward points or values earned only at that particular establishment, if desired a few establishments forming an alliance to honour each others' systems to club reward points or values earned at their respective establishments.

A method as described above, wherein the same can be profitably utilized as stated therein by the beneficiary buyer or by a group of beneficiary buyers.

A method for promoting sale of merchandise substantially as herein described.

A gift coupon/Smiles stamp for the promotion of sales, schemes and/or merchandise includes a sheet material having a plurality of separable units formed therein, said units being arranged in rows and columns, each unit carrying a value added feature therein having philatelic/exchange/encashment/credit or monetary or other similar value, one or more of said units having the same or different value addition/s, said value additions being for example, numerals, messages, teachings and similar information.

A gift coupon as described above, wherein the value additions are printed on one face of the coupon.

A gift coupon as described above, wherein the said rows and columns are of same or different sizes.

A gift coupon as described above, wherein the rows are formed horizontally or slantingly and each column is formed vertically or slantingly to form a multi faced coupon.

A gift coupon as described above, wherein the said coupon is a triangular sheet having one unit in the first row.

A gift coupon as described above, wherein said triangle is one, which is equilateral or right angular or isosceles or obtuse angled.

A gift coupon as described above, wherein the said coupon is a square, rectangle, or other polygonal sheet.

A gift coupon as described above, wherein said polygonal sheet includes a rhombus, a parallelogram or other multisided figures.

A gift coupon as described above, wherein all the units are of same size and shape.

A gift coupon as described above, wherein any one side of one or more units is independently provided with a slit while the other sides are provided with perforations.

A gift coupon as described above, wherein the slit is a continuous slit or intermittently formed slit.

A gift coupon as described above, wherein the slit is a through cut opening or a weakened tear line.

A gift coupon as described above, wherein the reverse or backside of the sheet is plain.

A gift coupon as described above, wherein the backside is gummed across the units fully or partly to make the units adhesive for collection purposes.

A gift coupon as described above, wherein a number of sheets are formed into a booklet.

A gift coupon as described above, wherein the sheets are of same or different type and advertise one or more items of merchandise.

A gift coupon as described above, wherein the merchandise are same or different in the same sheet.

A gift coupon as described above, wherein the merchandise are of the same or different manufacturers.

A gift coupon/Smiles stamp substantially as herein described with reference to the accompanying drawings.

### BRIEF DESCRIPTION OF THE DRAWINGS

For a more complete understanding of the present invention, reference is now made to the following description, taken in conjunction with the accompanying drawings, wherein like reference numerals represent like parts, in which:

FIG. 1 illustrates one example of a coupon/stamp configuration;

FIG. 2 illustrates another example of the coupon/stamp configuration;

FIG. 3 shows an example method for issuing the coupons/stamps;

FIG. 4 shows a simple issuance and redemption scenario;

FIG. 5 shows another example scenario for the issuance and redemption of SMile rewards that includes the entities for conventional credit card processing;

FIGS. 6A-6B show the issuance of SMile rewards in different buying circumstances;

FIGS. 7A-7B show two examples of a computer network for implementing an incentive program.

### DETAILED STATEMENT OF THE INVENTION WITH REFERENCE TO THE ACCOMPANYING DRAWINGS

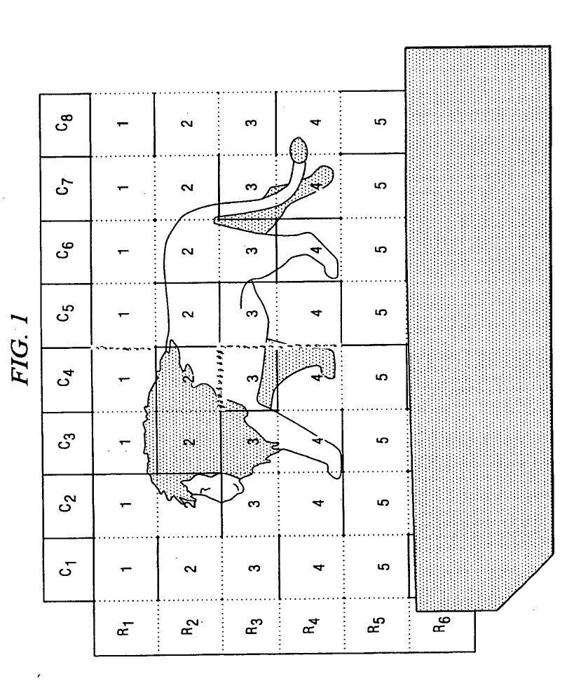

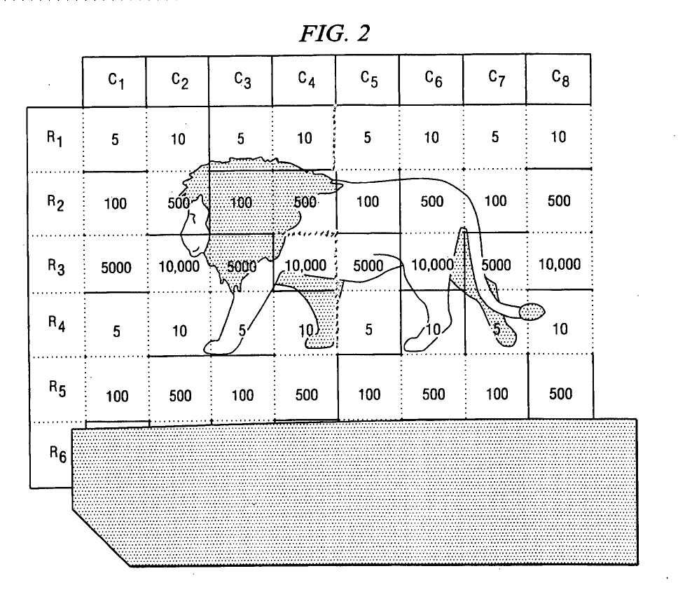

The invention is explained further with reference to the accompanying drawings in which FIG. 1 illustrates one type of SMiles stamps while FIG. 2 illustrates another type.

In FIG. 1, the SMiles stamps sheet is shown by numeral 1. It has a plurality of rows R1 to R6 and columns C1 to C6.

These can be square or rectangular, triangular or diamond shaped, trapezoidal or circular, elliptical or any other convenient shape.

These rows and columns can be separated by straight lines, vertical, horizontal, diagonal, slanting or wavy pattern or any suitable combination thereof.

It will be seen from FIG. 1, the whole SMiles stamp sheet has on the background, a picture of an animal. For illustration, we have shown a lion, The background can be of any picture of bird, nature, flags of nations, mountains, trees, animals, humans, abstracts, stars, sun, moon, globe or other planets or such umpteen items.

It can be of any suitable combinations thereof.

If desired, any one or more, column and/or row can be of specific colour or of multi colours.

It is possible to have selected columns and rows or all the columns and rows for this effect.

It is further possible to have in the background, a picture of a poet like Rabindranath Tagore and list below his books/poems etc.

Similarly, it is also possible to have a picture of a film personality and list his/her movies (directed or acted or produced, songs) etc.

It is possible to list the titles of books of a writer, list nursery rhymes, rivers, mountains, holiday spots, train routes etc.

There are thus umpteen number of messages that can be printed across the columns and rows as desired.

The messages that can be given are endless and there is no restriction to the type of messages, background or colour schemes.

The important feature is that the sides of the columns C1 to C6 and rows R1 to R6 have perforations like in a multi stamp sheet.

The basic difference is as follows:

In a normal stamp sheet all the four sides of each unit of a column or row is perforated and remain joined to the adjacent unit or units by the non-perforated portions.

These are in straight lines more particularly, these are in horizontal and vertical lines.

In the invented sheet, the units have either the same type of perforations or longitudinal slits or combinations thereof. Moreover, anyone side of each unit is almost fully separated from the joining side of the adjacent unit from any one side at least. This is contrary to known stamp sheets or similar gift coupons.

In a usual stamp sheet or similar gift coupon, it is only possible to tear off and then separate the edge rows units or tear off the edge row units and then the adjacent ones, one by one after tearing of the corner unit/s.

In the invented concept, in one embodiment, the facing two sides of adjacent rows or columns are fully separated to create a slot whose opening is sufficient to introduce a finger and separate that particular unit only by tearing off the other sides. Same way, the adjacent unit can be separated.

Thus, without tearing off any row or column, it is possible to tear off any selected unit in any column or row by suitable manipulation of the separation slit/s.

There are numerous ways of arranging the separation slits.

For example, these can be uniformly arranged along the rows or along the columns with one slot common to the two facing units.

It is also possible to have the tear slits in a combination of the rows and columns.

Yet another aspect is that the rows and columns can also be separated by wavy lines but straight lines are preferred for ease of separation.

Moreover, instead of being vertical and horizontal combination of square or rectangular rows and columns, it can be diagonal or trapezoidal, parallelogram or other suitable geometrical shapes. The common slit can be ideally formed on the side, which offers least resistance for tear.

The other novel feature is that each unit has a numerical value printed in preferably English script. This can be in Roman or in any other language script.

The number in each unit represents say, a basic value, say in rupees.

This can be of a currency value of international applications viz. dollars, pounds, euro, marks yens etc. and their sub-units if required.

The convenience of this system is as follows:

The first row can all have value of Rs. 1/-.

The second row can all have value of Rs. 2/- and so on.

That means these are uniformly valued.

If one has to say take out a value, say for Rs. 7/- in the usual stamps sheet formation, one will be required to tear of Rs. 1/- (seven columns) or Rs. 1/- or 2 columns and Rs. 2/- and Rs. 3/- of first column. However, it is essential to start with the corner and edge column and rows. It is not possible to take out a Rs. 5/- and Rs. 2/- from the central rows and columns.

Such a feature is provided in the novel construction.

From FIG. 1, it will be seen that the common slot between Rs. 3/- and Rs. 4/- of any inner row C1, C4 or C6 and column can be used or this purpose of tearing a value of Rs. 7/-.

However, this usage is more interesting and effective when we do not have serially numbered rupee values.

It can be seen from FIG. 2 that the each unit of each column and row carries different value. Thus, if one has to tear off for a value, say Rs. 5.102/-, it is possible by using the slot between Rs. 100/- and Rs. 5,000/- in row 3, column 7 and the slot under Rs. 2/- in row 2, column 2 and tear off values 5000, 100 and 2.

As in FIG. 1, it is possible to use the slot between Rs. 3/- and 4/- in row and column 3 tear off Rs. 3/- and Rs. 4/- value and similarly tear of Rs. 2/- value and Rs. 1/- value from column 2, row 4 to make Rs. 10/-.

Umpteen variations/patterns/designs are possible and these are all novel concepts.

The values can be printed starting from unit value, say Rs. 1/- and one can use arithmetic or geometric series or combinations thereof.

The SMile stamp sheet can be made more attractive by having colour patterned gold and silver cards, platinum and plain cards etc.

The various advantages of the invention are as follows:

It is World's first stamp based incentive program at clearing house level, to add value to customers.

It is basically a gift stamp or coupon, fashioned on the postage stamp. ‘The stamps will be in various denominations, to be given free at a specified rate, say 1%, as consumer incentive. Consumers can also buy these stamps at face value, Consumer products manufacturers can simply buy these stamps from us in bulk, for packaging along with their products. These can be even co-branded, if the order is quite a bulk.

The program is designed to work, more or less like the ‘mileage’ or other incentive earning scheme of airlines and some credit cards, with the important innovation that it is modeled on philately. Thus it is claimed that it could be a new invention.

Our most important differentiation is that of merging the concept with philately, to give birth to a wholly new concept of a universal incentive program PLUS a hobby.

The rewards will be distributed in the form of stamps (like postage stamps). These stamps will be of various denominations and printed with a series lot number and expiry date. There can be a place to write issuing ME number for increased security or there would be a barcode.

Another novelty in preparing these stamps will be that the back of the stamp which is left blank in postal stamps will be used to put information including security coding through barcodes or any other magnetic device. These may be collected in two way transparent sheets glued with a transparent adhesive or static or a pneumatic device.

Another novel aspect will be that though these will be printed in perforated sheets like the postal stamps, even each stamp in the same sheet can be different, adding to the novelty in the types of stamps.

The consumers can redeem the stamps either instantly for small gifts kept with ME or collect in a stamp book. The collected stamps can be redeemed against a variety of specified gifts, at SMiles redemption centre.

It is intended to induce consumers to start collecting thee stamps through creative strategies to create impulse e.g. publishing colourful topical stamps with on philatelic model. On redemption, the stamps can be cancelled and returned to the collector. There will be additional rewards for collecting a specified series.

Each STamps can also have the name of the city where it has been issued (city/country) like in postage stamps.

STamps will be printed in various denomination and sizes, like postage stamps. This will make them interesting and ease the operation also. Collecting SMile stamps itself will be a value proposition like philately. This will help create a perennial innovation, perhaps Worldwide reinventing an age-old hobby.

Processing of claims for gifts against stamps will be mechanized for speed and security. Latest computers and barcode systems shall be used for this. There may be a depository and exchange service for the collectors.

Pictures, puzzles, philatelic and/or information from various fields of learning.

Any one of each of the unit being separable independently from any other adjacent unit on any side of the same.

Said rows and columns being formed by perforations and slits in selected combination thereof around the units based on which unit is to be separated from which other adjacent unit.

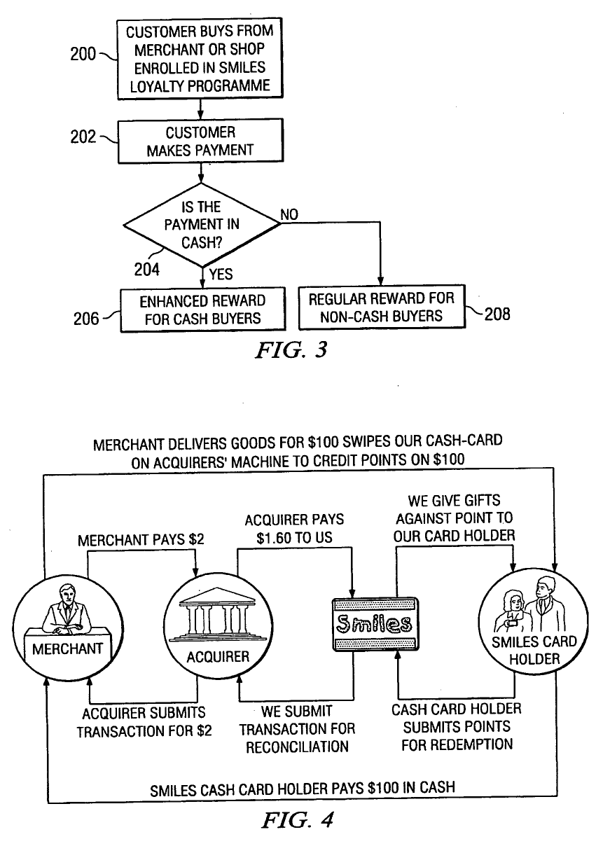

FIG. 3 shows an example method 200 for issuing the coupons/stamps. A customer pays for merchandise from a merchant at block 202. A determination is made as to whether the customer pays by cash or by credit card at block 204. In one scenario, the customer pays with cash, such as $100. Since the customer has used cash instead of a credit card to pay for the merchandise, the merchant has no obligation to pay to or get deducted by the credit card company a certain percentage of the purchase price as would be the case if the customer paid for the merchandise with a credit card. As a result, there is an incentive for the merchant to receive payment in cash rather than by credit card. To provide the incentive for customers to use cash instead of a credit card, the merchant can issue a coupon/stamp to the customer at block 206 that may be redeemed towards the purchase of other merchandise from the merchant at a future time. If payment was by credit card, the merchant may issue a lesser reward at block 208. The merchant may then promote the use of cash rather than a credit card to potential customer by advertising that greater reward offerings may be obtained if cash is used for payment instead of with credit cards. In another situation where the merchant may or may not have facility to honor payment cards, an incentive may be exclusively offered if the payment is through a cash instrument.

Instead of issuing a coupon/stamp, a cash card may be issued against a fee and/or on the basis of certain performance criteria, with or without a certain amount of credit applied thereto in accordance with the customer's purchase. An incentive may be applied by the merchant directly in various other forms like a gift, rebate, or deferred cash-back. Alternatively, the customer has an amount of credit in an account that can be used towards future purchases. Alternatively, a credit can be issued to a customer with an existing cash card and/or account. The credit may be in the form of actual dollars or points that represent some sort of value for later use towards future purchases or gift redemptions. The cash card may be a simple accrual card or could be a combination accrual card and credit card. The coupon/stamp/credit are in the form of SMiles rewards. The SMile rewards may include an expiration date upon issuance as desired by the merchant. The merchant would pay a clearing house for processing of the SMile rewards, probably at an equal or lesser rate than that charged by the credit card company. In yet another variation, there may be a different level of rewards on transactions where the deduction from the merchant is lesser, like a PIN based debit card payment. This reward can be lower than in case of paper transactions but greater than conventional signature based payment card transactions. Though the term credit card and cash card are discussed herein, the present invention contemplates the use of any type of payment card to include credit card, charge card, debit card, stored value cash card, and the like. Likewise, payment in cash or with cash is taken to mean payment by currency notes or checks including travelers check or any other payment means where there is no deduction from the amount the merchant eventually receives.

The customer can redeem the SMile rewards in a variety of ways. For example, the SMile rewards can be redeemed at the merchant towards the purchase of additional merchandise at a future date. The SMile rewards may be redeemed at a different merchant that also participates in the program. The customer may also be able to accumulate SMile rewards from various merchants within the program for redemption at one of the merchants in the program. Alternatively, the customer may redeem the SMile rewards through the clearing house issuer using a catalog or website that offers merchandise for sale. SMile rewards may also be redeemed into dollars or other currency and deposited into an account for use by the customer.

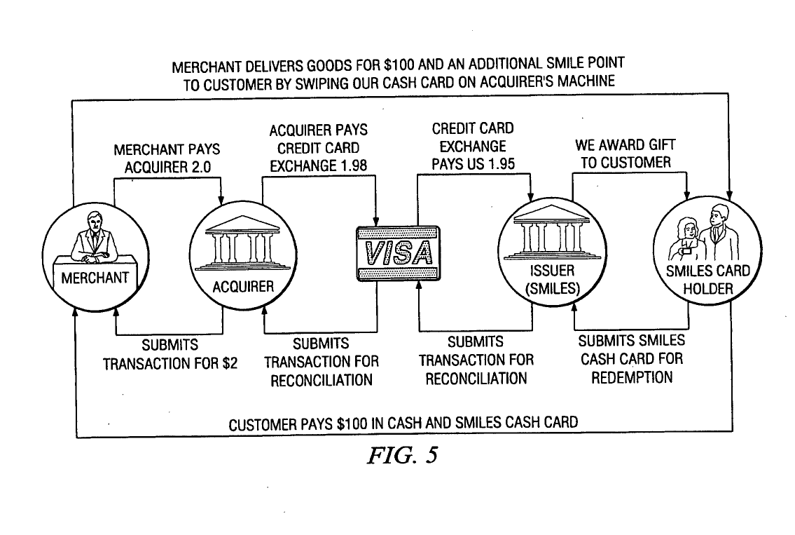

FIG. 4 shows a simple issuance and redemption scenario. In this example, the customer has purchased merchandise from the merchant using $100 cash. The merchant issues SMile rewards to customer pursuant to the cash purchase. The merchant pays the clearing house issuer for the processing of the SMile rewards. The customer redeems the SMile rewards through the clearing house issuer towards the purchase of merchandise provided by the clearing house through catalog or Internet offerings. The clearing house issuer will provide the merchandise to the customer upon verifying that the SMile rewards is valid for redemption. If a coupon/stamp is used, the clearing house issuer will cancel the stamp and return it to the customer for collecting purposes. There may also be an intermediate entity, an acquirer, that is in the processing loop to interface between the merchant and the clearing house issuer for the issuance and use of a cash card.

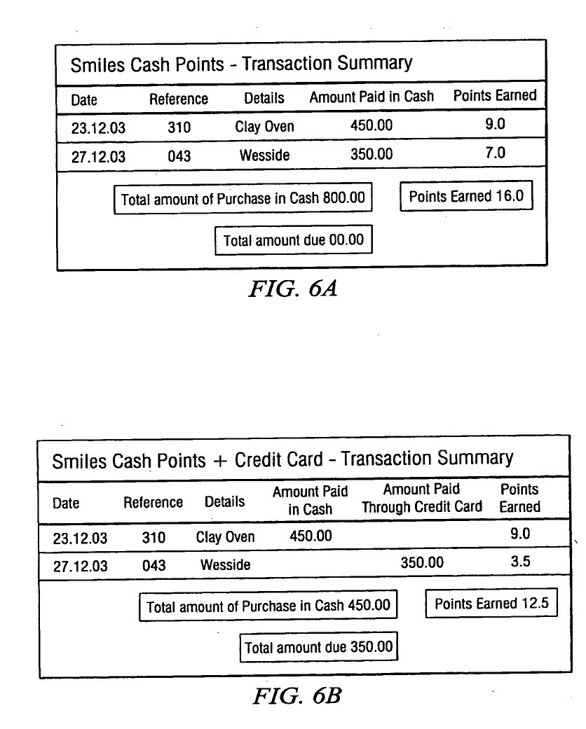

FIG. 5 shows another example scenario for the issuance and redemption of SMile rewards that includes the entities for conventional credit card processing. In this scenario, the customer pays for the merchandise using a combination of cash and SMile rewards. For the processing of coupons/stamps, the merchant verifies that the SMile rewards is valid for redemption and can process the transaction without any involvement of the other entities. The merchant can issue additional SMile rewards, the processing of which being paid to the clearing house issuer as discussed above, based on the amount of cash submitted by the customer for payment. The merchant may also include the amount of SMile rewards in determining what additional SMile rewards is to be issued to the customer. The merchant can perform the cancellation when coupons/stamps are used and return the cancelled coupons/stamps to the customer for collecting as desired. If a cash card is used in paying for the merchandise, the merchant will most likely interface with the acquirer to process the cash card payment as discussed above. If the cash card is also a credit card, processing includes submitting the transaction through the credit card company.

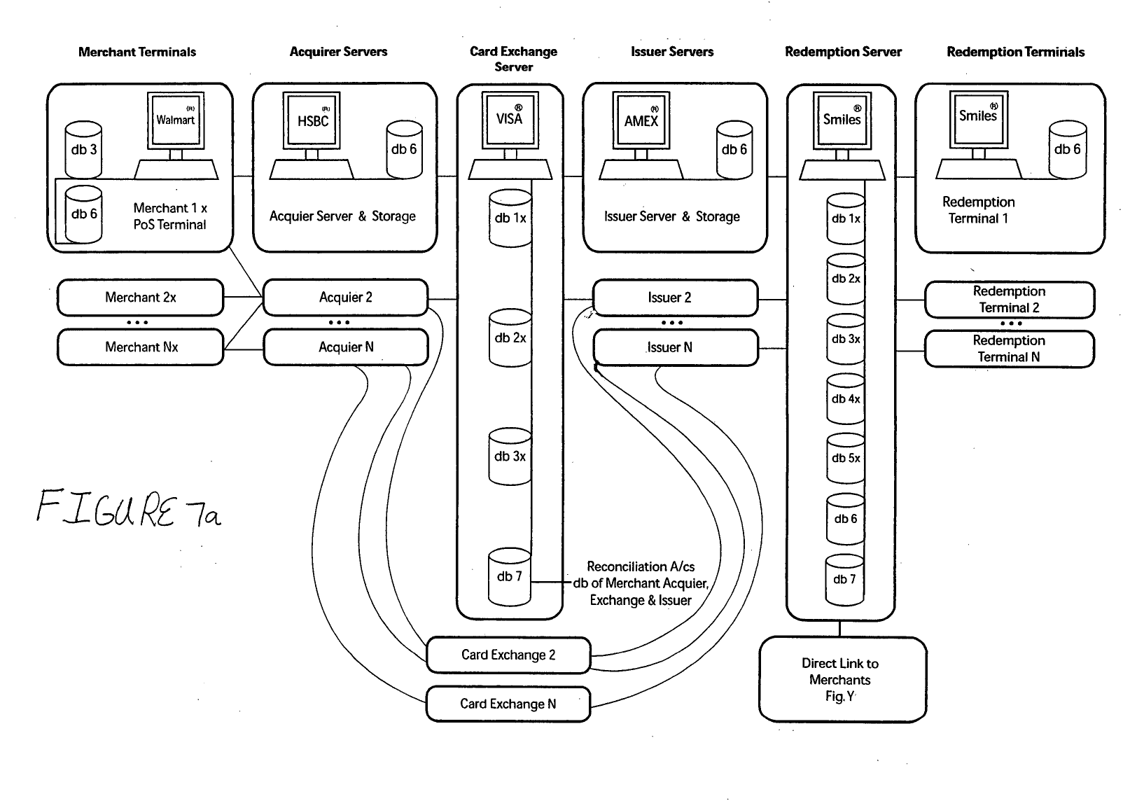

FIGS. 6A-6B show the issuance of SMile rewards in different buying circumstances. In FIG. 6A, a customer has paid for two items using cash. The merchant issues SMile rewards in accordance with the cash purchase for a certain number of points associated with the transaction. In the example shown, SMile rewards was issued to the customer as represented by the point values 9.0 and 7.0 for each item purchased. The customer may then redeem the SMile rewards associated with these point values for specific gifts or for future merchandise purchases as described above. FIG. 6B shows the circumstance where the same two items were purchased differently. As in FIG. 6A, the first item was purchased with cash and thus has the same 9.0 point value associated therewith. However, the second item in FIG. 6B was purchased by credit card. The processing of the credit card portion of the purchase is performed in a conventional manner with the credit card company receiving a percentage of the purchase price. As a result, a lower point value of 3.5 has been awarded for this purchase as compared to a similar purchase using cash. Therefore, a bigger reward is received by the customer if payment is made by cash instead of by credit card.

The present invention is associated with loyalty or incentive reward programs on a global scale, combining the points, coupon, and trading stamps concepts, improving the trading stamps to a philatelic stamps and thus bringing about far reaching benefits in consumer interest, aggregation of value, ease of operation, cost reduction and industrial application. Based on the premise outlined above, a method and system of disbursing reward points and reward coupons or trading stamps as incentive for purchases made or for rewarding the loyalty of consumers may include having the merchant enroll in a global rewards program wherein the merchant buys points against a consideration in cash or in kind or through an instrument of credit. These points may be awarded by way of a variety of instruments like a coupon or stamps or electronic points on a magnetic device, depending on the merchant's infrastructure and consumer's choice if any.

The stamps may be of infinite variety and in various denominations, like postage stamps, with the denomination and the city or country of issue and expiry date if any mentioned. The above stamps may be printed with security markings at its back or front face, such as a barcode or with other security features like a watermark or marks with special inks, perforations of a particular dimension, hologram, or the like. Additional information may be embedded on the stamp itself in the form of an optical image or electronic codes on a magnetic strip behind that can be read at a customer terminal with special devices like an electronic reader. For example in a series of stamps on specific encyclopedia items, the pictures can be on the stamps whereas the respective text entries can be read encoded therein electronically and read electronically by a customer terminal.

The reward stamps or coupons or points so awarded may be collected by consumers from a plurality of merchants enrolled in the program universally, without any need for the consumer to identify or enroll in any program. The reward instruments so collected are freely exchangeable and transferable like currency and are redeemed against consideration in kind or in cash as per catalogue published from time to time, from a centralized redemption office, or selectively at the point of purchase itself. The philatelic stamps provide go beyond mere collection by providing an added advantage of deriving tangible economic benefit apart from all other benefits of philatelic stamps as we know it. The consumer derives additional pleasure of pursuing a philatelic hobby apart from the value of the incentive itself.

The consumer may set up a membership account by signifying an intention to set up a membership account of a particular type at the time of exchange or redemption. Such account may be of a Philatelist or otherwise, signifying that whether the consumer would like to pursue collecting the reward stamps as a hobby or not. A unique account number is assigned to each of such consumers. There can be one membership account for a plurality of individuals grouped as a family, company, or a voluntary friend circle or several individual accounts may be joined by a code for such a group. The Philatelist account holder will be returned the reward stamps after redemption, duly cancelled like a used postal stamp, by application of a cancellation mark using cancellation dies or other such mechanical or hand-held devices, if so desired.

The Philatelist consumer can exchange other kinds of reward instruments like coupon or electronic points, for stamps, by signifying his intention for such exchange for a specific or non-specific stock of stamps in mint condition by surrendering other kind of instruments and signifying an intention for such exchange for a specific or non-specific stock of stamps in cancelled condition, from a centralized depository, by surrendering other kind of instruments for redemption.

The consumer can collect rewards without any need for identification or enrollment by making a purchase from a merchant enrolled in the program and signifying an intention to be rewarded directly without any identification or enrollment. The merchant calculates the value of the reward as per consideration received and issues the reward value by any desired transferable instrument such as a coupon or a stamp or an electronic code. A coupon may be issued to a consumer in a pre-printed format or through a coupon generating machine such as franking machine or a digital printer, with alpha-numeric and or bar codes signifying its value that can be traded for any other instrument viz. reward stamp or points, or redeemed directly for consideration of such value.

In another scenario, customers may enroll for a fee and in turn will get an incentive directly from the merchant by way of a rebate, credit, or gifts, when they pay for their purchases with cash. A customer may have a payment card and a Smiles membership card for which a fee has been paid. If the customer buys with the non-affiliate payment card, the merchant loses a percentage to credit card administration. However, if payment is made with cash, the merchant can let the customer have that percentage with the net being the same to the merchant. Another variant of the above would be use of a payment card affiliated to Smiles that can cover both the situation in the example

There may be a clearinghouse that can handle and integrate other incentive or loyalty programs. The clearing house may contract with other incentive or loyalty programs to join the universal program identified above by agreeing to mutually exchange each other's rewards at a specified rate. The consumer may opt for such specific joint or co-branded memberships in establishing the membership account. The so contracted joint party may eventually extinguish its own program and become s fully merged in the universal program.

The merchant may disburse the rewards on a higher specified rate to those consumers who buy in cash rather than through a credit or debit card or through such other instrument on which there is a deduction from the amount the merchant eventually gets. The rewards may be printed in the form of attractive stamps of infinite variety in various denominations like postage stamps, with the denomination and the city or country of issue and expiry date if any, with or without a unique serial number. These reward stamps may be printed in a variety of shapes and sizes, using various material like paper, plastic, metallic foils, etc. and are dispensed in various ways such as perforated sheets, sealed envelopes containing specified variety and denomination, automated dispensers, and on-line printing option via internet, with or without a unique number or a barcode. The material printed on the reward stamps may include various themes of interest to various social strata. The themes may be printed in limited number to make them rare. In addition, the themes may be deliberately misprinted to make them rare. The back of these reward stamps may be used for printing any information. The reward stamps can be bought and sold for legal tender, at specified rates. The whole or the part of the information printed on or behind the stamp may exclusively or partly relate to a particular seller or a particular product.

A Philatelic bureau may be provided for the members to offer the following services: issue of inaugural covers for new stamps, organizing exhibitions and contests, and education and promotion. Treasury or depository services to members may be provided by acting as a bank for safe custody of reward stamps. The cancelled stamps may also be bought and sold at specified rates by the bureau. Services and any aspects of the universal program may be administered through the Internet for global application.

Universal program may be implemented in combination with a Credit Card or Debit Card program. The rewards may be fully exchangeable, transferable and can be bought, sold, gifted, or bequeathed. The reward may have a specified tenure for redemption after which it is either forfeited or transferred to a specified account or donated to an approved charity.

Consideration is expected to be received from the merchant disbursing the rewards if administered by a clearinghouse separate from the merchant. The merchant may be presented with various options for issuing rewards by way of a brochure. The merchant chooses the option or options most suited to its business and provides the consideration in return for the stock of rewards to be disbursed. The merchant may replenishes the stock when desired by reordering and remitting consideration. The merchant may pay the consideration either in cash or in kind or a combination.

An item may be provided to the person redeeming the rewards instrument. The person presents the instrument for redemption at a redemption counter, in person at the merchant, through a courier, or through the Internet. The person may choose the item through a catalog offering. The rewards instrument is cancelled and the desired item is provided. The person may choose to have the item delivered after deducting delivery costs from the reward itself. The merchant enrolled in the program can be at any level in the supply chain including: a manufacturer, an intermediary like a whole-seller or an agent, a retailer, or a member of a multi-level marketing chain. The incentive instrument may be put in or on the package of merchandise.

Online and offline merchants may be seamlessly enrolled in the universal program. The offline merchants may be authorized to issue points by way of coupons and stamps. The offline merchants may send a periodic account which is processed by the centralized system as a batch. The offline merchants may have the option of contacting a call center to obtain any information and authorization they need. The offline merchants may log on to a website on the Internet through any computer including public networks, to do the same as above.

An alliance may be established with postal services of various countries for reciprocal or one-way exchange and distribution arrangements. Reciprocal or one-way alliances may be made with other rewards programs, wherein the alliance partner agrees to issue and honor global rewards points or stamps interchangeably with their own points, on a reciprocal basis. The alliance partner may completely outsource their rewards program to the universal program disclosed herein. The alliance partner may also completely merge their rewards program to the universal program disclosed herein. The universal program acts as an outsource for an existing or new standalone rewards program, with or without any reciprocal or one-way exchange of reward points. The universal program may be appointed as an outsourced third party contractor for running the existing program of standalone or limited alliance programs with all features intact, with or without an exchange arrangement with the universal program. The existing program operator transfers consideration as per reward points issued, in favor of the universal program. The consideration is used for redemption by the consumers of the existing program, with or without an option of exchanging their points into global currency and thus claiming a different consideration. In the event of such an exchange taking place, the consideration issued by the existing program is used in the universal program if a two way exchange has been agreed upon by the standalone program. The final step is a complete merger of the existing program into the universal program if desired by the existing program. The instruments of reward points may be specially made for alliance or outsourced programs with or without specific declaration, pictures, or coding to this effect.

The present invention has, among others, the following unique advantages. These advantages include universal application in terms of who can be a member establishment (giver) or user (collector), virtually without any limitation as to reach of computer networks or carrying electronic cards. It allows for joining both a manual and an electronic system seamlessly, cutting across geographical, technical, and size barriers for both giver and collector. There is ease and cost-reduction for establishments because the merchants will not have to maintain their own incentive programs, which require sophisticated systems and more manpower in administering the scheme. There is a further increase in application because of the fact that the reward Stamps can be put in or on the package of various products (electronic points can't be). Centralized redemption will mean further savings of time and effort on the part of establishments and better choice to the consumer. Making reward Stamps in different denominations, sizes and variety will add to ease of operations and joy due to variety for the collector. A tremendous increase in ease and value addition to receivers occurs due to the lack of any procedural hassle, better protection of privacy, aggregation and accumulation of incentives over a hugely wider base, joy of philatelic collection and greater accountability due to third party involvement. A further value addition occurs due to easy transferability of the incentive earned to whomever the original user wants to gift, bequeath, or sell. In the system presented, one can opt for collecting a coupon or stamps or points for redemption, each having the same currency value. Combination of incentive points or coupons or stamps freely exchangeable for each other is unique and has a dramatic effect of widest aggregation, application, and ease for both the merchant and the consumer. There is no known parallel to the ‘Cash Card’ device for special benefits to those who buy in cash. This can reinvent philately as a hobby as there is no other known system, except the post-office, that issues stamps in an infinite variety, bringing joy for collectors even after use. Alliances or merges can be readily formed with existing rewards programs in a seamless manner. The conventional slow monotonous process of point collection is transformed into a meaningful, colorful, and enjoyable hobby of stamp collection.

Conversely, the technical problems of the prior art sought to be solved by the invention, among others, include enrolling establishments and consumers with or without access to computer networks, in a global alliance program. Establishments have to plan, configure, and implement their own incentive programs, which is costly and time consuming, due to uneconomic scale. There are infrastructure limitation on very small establishments who may not be able to afford the cost of instituting their own loyalty program or participate in a limited alliance program due to lack of resources. The reward points can't be put in or on the package of products that might be sold through merchants and at various levels of the supply chain, who may or may not be participating in any reward program. Consumers have to keep a variety of identification cards and separate accounts for different schemes. Consumers can't aggregate and accumulate benefits across a wide number of givers. Consumers find both the existing systems - points and trading stamps, mundane, as no immediate joy can be derived particularly from collecting these, except the imminent joy on redemption perhaps. As a result a majority of them don't keep track and don't redeem. There are always procedural hassles in present day loyalty programs, which expect consumers to enroll. These hassles include the privacy of consumers being frequently breached, the transferability of the incentive earned to whomever the original earner wants to gift, bequeath, or sell is suppressed, resulting in a limitation on currency. Cash purchasers have no means to get back their legitimate discount considering that effectively all credit card purchases are discounted. With the advent of franking machines increasingly used by the post offices and increasing use of private courier service, philatelists' delight in collecting colorful stamps with meaningful pictures of curios and educative value has become limited. A system for allowing existing loyalty programs to evolve into a global alliance is needed. Sustained consumer interest is difficult to achieve in any loyalty program due to (a) monotony and (b) slow aggregation.

The present invention proposes a novel rewards program combining the concepts of points and stamps or coupons, bringing about unexpected benefits of application on a much larger industrial scale, through aggregation. The consumer derives much greater value by aggregation, ease of use, and protection of privacy by cutting down on formalities and enhanced delight for continued interest by bringing in variety and other intellectual stimuli. A wider area of application is provided by including relatively smaller entities who may not be able to afford their own programs or form a limited alliance program or join a computerized network. Most merchants already pay around two percent, more or less, on credit card transactions. The present invention contemplates paying back to the cash purchasers an incentive in lieu of this by introducing a cash buyer program somewhat opposite of credit card In fact, many credit card companies and other establishments like airlines, retailers, etc. have their own incentive schemes. The present invention also contemplates enrolling such establishments as outsource and act as a clearinghouse of all such schemes. Value can be added to a vast body of general consumers by making them avail incentives on a larger scale, encouraging small saving in masses, and boost consumer demand. Through the present invention, a global business method can be established to promote the sale of merchandise.

The present invention provides a global alliance solution for running a loyalty or incentive or rewards program. The present method and system disclosed herein make it possible for a plurality of establishments to join in a global program, without any limitation of size, geographical location, or infrastructure available. This is made possible primarily by combining systems of incentive coupons, reward stamps, and electronic reward points in a seamless manner. Seller establishments joining the program of the present invention will just have to buy the points from a centralized rewards office, against specified consideration in cash or in kind or both. The seller can choose from the points or miles in the form of coupons, stamps or points, or any combination there of, to be disbursed at a specified rate to the Seller establishment's consumers, without insisting on identification formalities. The points or miles may be issued in the form of colorful stamps of various denominations, bearing various designs. In another embodiment, the merchant can decide to join an on or off line option for issuing electronic points or coupons in addition to stamps. The merchant may also enroll with the central rewards office for the redemption program, wherein a particular variety and quantity of gifts may be given for spot redemption by the consumer. On giving effect to such redemption the seller receives a consideration from the central redemption office. The consumers who receives such points or miles may collect these over a period of time to redeem on the spot if the merchant has in stock the consideration desired by the consumer. The consumer may be offered options to take the point or miles either in the form of coupons or stamps or electronic points, depending on the availability of options with the merchant and preference of the buyer. The points, stamps, coupons, or miles so issued can always be changed from one form to another at the central rewards office. The consumer can collect these points or miles for later redemption from the central rewards office, against specified consideration according to a threshold quantity or variety. The consumer can also approach the central rewards office for exchanging one form of reward instrument into another. Safe custody of the reward instruments may also be requested at the central reward office itself. The consumer who decides to collect these stamps as a hobby, apart from taking the benefit of redemption against a specified consideration, will signify so at the time of claiming redemption so that the stamps could be returned to the consumer after putting a cancellation mark on the same. There can be further rewards associated with collection of a particular threshold quantity or variety as announced from time to time. The merchant will preferably offer higher points or mileage for cash purchasers to compensate for the discount generally retained by the credit card companies on credit card transactions. Co-branded credit cards may be provided offering these global incentives at specified rates. Reciprocal alliances with other rewards programs, to issue and honor one another's points interchangeably, may be formed. The method and system disclosed herein can act as an outsource for administering an existing or new standalone program, with or without a one-way exchange. Such an alliance can take the form of complete merger with the universal program presented here.

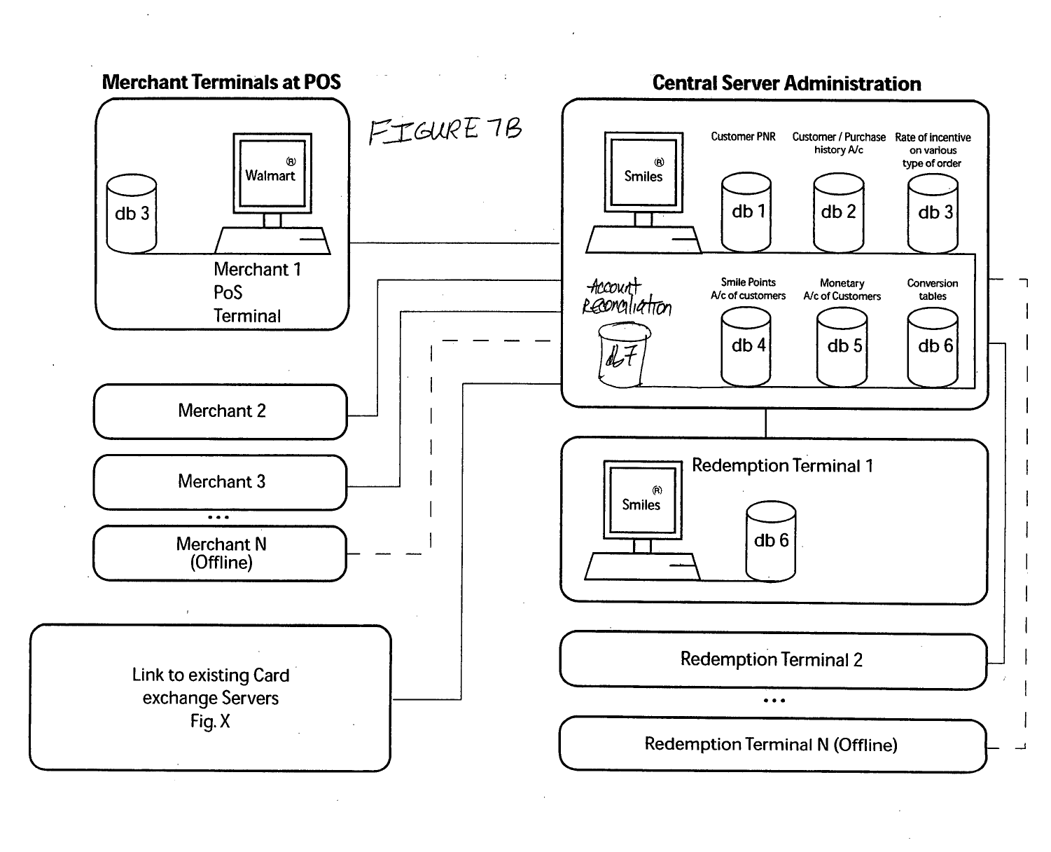

FIGS. 7A-7B show two examples of a computer network for implementing an incentive program. In FIG. 7A, the incentive program is implemented within an existing payment system network 700. Network 700 includes merchant terminals 702, acquirer servers 704, card exchange servers 706, issuer servers 708, redemption server 710, and redemption terminals 712. Terminals and servers may be linked by any of various network access technologies including wireline, wireless, and fiber optic connection links. Information within databases of the terminals and servers may be shared and distributed across the network according to the desired network implementation.

In FIG. 7B, an incentive system network 750 may be established between the merchant terminals 702, the redemption server 7010, and redemption terminals 712. In network 750, the acquirer, card exchange, and issuer servers may be bypassed, if so desired, in order to establish a merchant only issuance and redemption process when the other entities are not needed to participate. Redemption server 710 includes one or more databases that store information related to the program. For example, redemption server 710 may include a customer PNR database 752, a customer purchase history database 754, a rate of incentive database 756, a SMiles points database 758, a monetary database 760, a conversion database 762, and a account reconciliation database 764. Customer PNR database 752 includes information pertaining to the customer. Customer purchase history database 754 includes information pertaining to the customer's buying habits. Rate of incentive database 756 includes information pertaining to the type and amount of incentive to be applied for a particular purchase. SMile points database 758 includes information pertaining to an amount of SMile points that have been credited to the customer. Monetary database 760 includes information pertaining to a currency amount available to the customer. Conversion database 762 includes information pertaining to a customer's ability to exchange certain incentives for other incentives. Account reconciliation database 764 allows redemption server 710 to apply incentives within the existing payment system network of payment cards shown in FIG. 7A. Though shown as separate databases, the above described information may be stored in fewer or more databases and can be accumulated together in one or more databases as desired.

As shown above, an incentive point service process may be implemented through the Internet. On a computer server, accounts of each customer may be kept in a one database and the customer record with a unique PNR is kept in a same or different database. The server is linked to a Point of Sale (PoS) terminal of the merchant by means of the computer network and related software. An incentive may be applied at the PoS terminal upon a customer buying merchandise associated with the incentive. The incentive may be maintained in a same or different database. As before, a first incentive may be applied if the payment is made through cash currency notes and a second incentive may be applied if the payment is made through a payment card. The incentive may be offered in the form of coupons or stamps of innumerable designs of philatelic value. Alternatively, the incentive may be credited as SMile points in a same or different database linked to an accrual card with PNR, with or without the added features of a payment card. The incentive -may be applied interchangeably regardless of form at the option of the consumer. One form of incentive can be exchanged for another, at the option of the consumer. A customer, who has been awarded incentives in the form of coupons or stamps, may present them for redemption at a terminal linked to the server through the computer network and related software. The redemption terminal may connect to the server and check the customer's identity in the database and update the account in the database while awarding the incentive. The coupon or stamp may be cancelled like a used postage stamp and returned to the customer for collection purposes. The incentive applied may also be converted into monetary terms and credited into the database in the server and represented as a monetary account of the customer. This process may be carried out through existing payment system networks of payment cards. A new form of payment card may be introduced for facilitating the accrual of points as above, with or without in combination with a conventionally known payment card like a credit, debit, charge, or stored value card. This may be achieved by collaborating and co-branding the card with an existing entity in the existing payment systems, including a Merchant, an Acquirer, a card Exchange, and an Issuer.

The merchant and/or redemption terminal may connect to an Internet server provided by an ISP, intermittently or continuously, through e-commerce software. The consumer can access his account on the server connected to the Internet, through his computer terminal that also connected to the Internet, through a browsing software means. The consumer may transact some of the features mentioned above on his computer terminal connected to the Internet. The consumer may order for those transaction features that can not be completed on the Internet for delivery through other available means. For example, the consumer may, after browsing through the available options as above, order over the Internet through email or an e-commerce software a particular variety of gifts or stamps in exchange of accumulated points, after deducting a delivery charge from the incentive itself, and the same be delivered through post or a specified courier service.

The present invention can be implemented as an incentive point service process through computer network hardware and related software means wherein, on a computer server, accounts of each customer are kept in a database whereas the customer record with a unique Person Name Record (PNR) number is kept in the same or a different secured database. The server is linked to the Point of Sale (PoS) terminal of the merchant by the means of a computer network hardware and related software. An incentive is applied through data processing means at the PoS terminal, upon a customer buying merchandise associated with the incentive, as per a database. A first incentive is applied through data processing means, if the payment is made through cash currency notes and a second incentive is applied through data processing means, if the payment is made through a payment card including a credit card, a debit card, a charge card, or a stored value cash card.

The incentive may be offered in the form of coupons or stamps of innumerable designs of philatelic value, with a unique number or an electronic code or is credited as SMile points in a database linked to an accrual card with a PNR number, with or without the added features of a payment card such as a credit, debit, charge, and a stored value cash card.

A customer who has been awarded incentive as coupons or stamps may present the same at a redemption terminal linked to the server through a computer network and related software. The redemption counter terminal connects to the server and through data processing means checks the customer's identity in the first database and updates his account in the database, while awarding the incentive voucher as per a conversion table in the database. The coupon or stamp is cancelled like a used postage stamp through application of a mark by manual or mechanical means and returned to the customer for collection purposes.

The incentive is applied as above in the form of stamps or points or a combination thereof interchangeably, at the option of the consumer, as per a conversion table in a database. The consumer can also exchange one form of the reward for another, at any stage including at the stage of redemption. For example, before the redemption, the stamp can be exchanged for points credited in the customer account. Alternatively, at the redemption stage, the customer may demand cancelled stamps for points redeemed. Likewise, the customer may demand the coupons or stamps be retained and exchanged for SMile points credited in the fourth database, or vice-versa, fully or partly.

This conversion may be effected utilizing a conversion table in the database through data processing means. A conversion chart with various options for the consumer, presenting a particular quantum of points or coupons or stamps or all, may be generated and communicated to the consumer through hardware means including a printer and an electronic touch-screen. The consumer may use the chart to select his options and the same may be serviced through data processing means and computer peripheral hardware and software means like a Touch-screen Kiosk and Optical Character Recognition (OCR). At the option of the consumer, the incentive applied may be converted into monetary terms as per a conversion table in the database and credited into a database in the server consisting of monetary accounts of customers, through data processing means.

The above may be implemented through existing payment system networks and payment card means including a credit card, a debit card, a charge card, or a stored value cash card, wherein reconciliation accounts of merchant, acquirer, card exchange, and issuer is stored in a database. The incentive converted into monetary terms may be credited into existing payment system accounts of the consumer.

The philatelic incentive coupon/stamp in innumerable designs described earlier may be printed with or without a unique number or a computer readable barcode or magnetic ink character recognition (MICR) for application in the computerized process. An Accrual Card with a memory chip or a magnetic strip, with or without in combination with one or more of existing payment card devices including credit card, debit card, charge card, and stored value cash card, is additionally provided for implementation in the computerized process. The card as described above may have the full PNR details or only the number to protect the privacy of the consumer. Added incentives may be applied through data processing means, on reaching predetermined thresholds in terms of quantum of incentives collected and/or redeemed. Offline merchant and redemption terminals may be provided for implementing the process through batch data processing.

The PNR with a unique number may be kept secured, through computer encryption or other hardware and software security means, in a separate database accessible only to a designated part of system administration. All the other transaction data may be processed on the basis of such unique numbers accessible to the other part of system administration, while the detailed PNR may remain in encrypted form to protect the privacy of the customer.

In summary, a unique coupon/stamp is provided for redemption purposes against specified gifts or for the future payment of merchandise. The coupon/stamp provides a collection hobby for the customer as a result of the issuance with value added features and subsequent cancellation and return of the coupon/stamp to the customer. In addition, a method for issuing and redeeming a SMile rewards is provided that emphasizes the purchase of merchandise with cash rather than by credit/debit/stored value card. By avoiding a percentage of the purchase that would be received by the credit/debit/stored value card company in response to a credit card purchase, the merchant can increase the probability of repeat business from the customer preferring to pay in cash through this program.

Thus, it is apparent that there has been provided, in accordance with the present invention, a unique coupon/stamp and various methods for issuing and redeeming SMile rewards is/are provided that satisfies the advantages set forth above. Although the present invention has been described in detail, various changes, substitutions, and alterations may be readily ascertainable by those skilled in the art and may be made herein without departing from the spirit and scope of the present invention as defined in the following claims. Moreover, the present invention is not intended to be limited in any way by any statement in the specification that is not otherwise reflected in the appended claims.

1. A coupon/stamp for the promotion of sales, schemes, and/or merchandise, comprising:
a sheet material having a plurality of separable units formed therein, the units being arranged in rows and columns, each unit carrying a value added feature therein having philatelic/exchange/encashment/credit or monetary or other similar value, one or more of the units having same or different value added features, the value added features being represented by any of numerals, messages, teachings, and information, wherein any one side of one or more units is independently provided with a slit while the other sides are provided with perforations.

2. The coupon/stamp of claim 1, wherein the value added features are printed on one face of the coupon/stamp.

3. The coupon/stamp of claim 1, wherein the rows and columns are of same or different sizes.

4. The coupon/stamp of claim 3, wherein the rows are formed horizontally or slanting and each column is formed vertically or slanting to form a multi-faced sheet.

5. The coupon/stamp of claim 1, wherein, the slit is one of a continuous slit or intermittently formed slit.

6. The coupon/stamp of claim 1, wherein the slit is one of a through cut opening or a weakened tear line.

7. The coupon/stamp of claim 1, wherein the reverse or backside of the sheet material is plain.

8. The coupon/stamp of claim 7, wherein the backside of the sheet material is gummed across the units fully or partly to make the units adhesive for collection purposes.

9. The coupon/stamp of claim 1, wherein the slits facilitate removal of an individual unit of the sheet material.

10. The coupon/stamp of claim 9, wherein the individual unit may be independently separated from the sheet material without affecting the integrity of the other units in the sheet material.

11. A method of providing purchasing incentives, comprising:
receiving payment at a store for one or more items of merchandise from a customer;
issuing a first reward incentive if payment is made with cash;
issuing a second reward incentive if payment is made with a payment card not affiliated with the store.

12. The method of claim 11, wherein the first and second rewards may be any one or more of a coupon, stamp, credit, or point that represent a certain amount of value.

13. The method of claim 11, further comprising:
applying any of the first and second reward incentives to the payment card.

14. The method of claim 11, further comprising:
purchasing the first and second reward incentives for issuance from a distributor.

15. The method of claim 11, further comprising:
receiving payment for the item of merchandise by previously issued reward incentives.

16. The method of claim 15, further comprising:
issuing a third reward incentive in accordance with payment being made by previously issued reward incentives.

17. The method of claim 11, wherein the first reward incentive is greater than the second reward incentive.

18. the method of claim 12, further comprising:
receiving any of coupons, stamps, credit, and points issued as reward incentives;
applying the received coupons, stamps, credit, points as redemption for an item of merchandise.

19. The method of claim 18, wherein the coupons, stamps, credit, and points can be used interchangeably for redemption.

20. The method of claim 18, wherein the item of merchandise is predetermined in response to the issued reward incentives being redeemed.

21. The method of claim 18, further comprising:
affixing a cancellation mark on any received coupon and stamp;
returning the coupon or stamp with the cancellation mark to the customer for collection purposes.

22. A computer network operable to implement an incentive point service process, comprising:
a redemption server operable to store information pertaining to accounts of a customer, a record and a unique person name record number of the customer, and incentives to be applied to purchases made by the customer;
a point of sale terminal at a merchant linked to the redemption server by a computer network of hardware and related software, wherein an incentive is applied pursuant to the redemption server through data processing means at the point of sale terminal in response to the customer purchasing merchandise associated with the incentive, a first incentive being applied through the data processing means if the payment is made through cash currency notes and a second incentive being applied through the data processing means if the payment is made through a payment card including a credit card, a debit card, a charge card, or a stored value cash card.

23. The computer network of claim 22, wherein the incentive being offered is in the form of coupons or stamps of innumerable designs of philatelic value with a unique number or an electronic code, the point of sale terminal operable to print out the coupon or stamp upon completion of a purchase transaction by the customer.

24. The computer network of claim 22, wherein the incentive being applied is credited as points in a database of the redemption server associated with an accrual card and the person name record number.

25. The computer network of claim 22, wherein the redemption server includes a database to facilitate incentive interchangeability with information associated with a conversion of one type of incentive to another type of incentive.

26. The computer network of claim 22, further comprising:
a redemption terminal linked to the redemption server, the redemption terminal operable to allow a customer who has been awarded an incentive to present the incentive for redemption.

27. The computer network of claim 26, wherein the incentive being redeemed is a coupon or stamp, the redemption terminal connecting to the redemption server upon redemption of the coupon or stamp by the customer and through data processing means verifies the customer's identity and account, the redemption terminal operable to redeem the coupon or stamp upon verification, place a cancellation mark on the coupon or stamp, and return the coupon or stamp to the customer for collection purposes upon completion of its redemption.

28. The computer network of claim 26, wherein the incentive being applied is points accumulated and stored in a database of the redemption server, the redemption terminal operable to connect to the redemption server upon redemption of the points by the customer and through data processing means verifies the customer's identity and account, the redemption terminal operable to redeem the points upon verification.

29. The computer network of claim 28, wherein the redemption terminal is operable to exchange the redeemed points for a coupon or stamp of equivalent value upon request by the customer, the redemption terminal operable to provide the coupon or stamp to the customer for collection purposes with a cancellation mark affixed thereto.

30. The computer network of claim 26, wherein the incentive is points or coupons or stamps, the redemption terminal operable to connect to the redemption server upon redemption of the points or coupons or stamps by the customer and through data processing means verifies the customer's identity and account, the redemption terminal upon verification operable to exchange points for coupons or stamps, or vice versa, of equivalent value predetermined in accordance with a conversion table, the points being maintained in a database at the redemption server, the redemption terminal operable to perform the exchange in full or in part.

31. The computer network of claim 26, wherein the redemption terminal is operable to present redemption options to the customer presenting a particular quantum of incentives, the options provided by the redemption terminal including an exchange capability for each type of incentive being redeemed by the customer.

32. The computer network of claim 31, wherein the redemption server is operable to apply added incentives through data processing means upon the particular quantum of incentives being redeemed reaching a predetermined threshold

33. The computer network of claim 26, wherein the redemption terminal is operable to receive inputs from the customer through one or more of touch screen inputs and optical character recognition.

34. The computer network of claim 26, wherein the redemption terminal is operable to convert an incentive being redeemed by the customer to monetary terms predetermined in accordance with a conversion table, the redemption terminal operable to credit the monetary terms in an account associated with the customer stored in a database at the redemption server.

35. The computer network of claim 22, wherein the redemption server and merchant terminal are operable to interface with existing payment networks using payment cards that include an acquirer server, a card exchange server, and an issuer server, the redemption server operable to apply incentives issued in response to the purchase to the payment cards through a reconciliation database.

36. The computer network of claim 35, wherein the redemption server is operable to convert the incentive into monetary terms, the redemption server operable to credit the monetary terms to existing payment card accounts of the customer.

37. The computer network of claim 26, wherein the redemption server, the point of sale terminal, and the redemption terminal have no real time communication capability, the issuance and redemption of incentives being performed off-line through a batch data processing technique.

38. The computer network of claim 22, wherein the redemption server provides access to the customer through the Internet to allow the customer to access account information.

39. The computer network of claim 22, wherein the incentive being offered is an accrual card with a memory chip, a magnetic strip, or other storage capability, the point of sale terminal operable to issue a new accrual card to the customer or update an existing accrual card possessed by the customer with the incentive earned in accordance with the purchase.

40. The computer network of claim 39, accrual card is an existing payment card such as a credit card, a debit card, a charge card, and stored value cash card.

41. The computer network of claim 22, wherein the redemption server maintains security of the customer's identity and unique person name record number accessible only to designated system administration, additional information associated with the customer being accessible through the customer's identity and unique person name record number.
